(19) United States
(12) Patent Application Publication
(10) Pub. No.: US 2009/0267024 A1
(43) Pub. Date: Oct. 29, 2009

(54) Inorganic Sulfate Ion Scavenger, Inorganic Scavenging Composition, and Electronic Component-Sealing Resin Composition, Electronic Component-Sealing Material, Electronic Component, Varnish, Adhesive, Paste, and Product Employing Same

(76) Inventor: Yasuharu Ono, Aichi (JP)

Correspondence Address: KRATZ, QUINTOS & HANSON, LLP, 1420 K Street, N.W., Suite 400, WASHINGTON, DC, 20005, US

(21) Appl. No.: 12/084,894

(22) PCT Filed: Dec. 25, 2006
(86) PCT No.: PCT/JP2006/325733

§ 371 Date: May 13, 2008

(30) Foreign Application Priority Data
Jan. 6, 2006 (JP) 2006-001598

(51) Int. Cl. C08K 3/10; C09K 3/00; C01F 5/24; C01F 7/02; C01F 17/00

(52) U.S. Cl. 252/184; 423/420.2; 423/625; 423/263; 524/403; 524/424; 524/430; 524/437

(57) ABSTRACT

The present invention relates to a novel inorganic sulfate ion scavenger that is environmentally friendly and has high performance. With regard to the inorganic sulfate ion scavenger of the present invention, the amount of ionic impurities leaching out in pure water is no greater than 500 ppm and the amount of sulfate ion leaching out in pure water is no greater than 30 ppm. Furthermore, the present invention relates to an inorganic scavenging composition comprising the inorganic scavenger, and to an electronic component-sealing resin composition, an electronic component-sealing material, an electronic component, a varnish, an adhesive, a paste, and a product employing the inorganic scavenger or the inorganic scavenging composition.

### TECHNICAL FIELD

The present invention relates to an inorganic sulfate ion scavenger and an inorganic scavenging composition. Furthermore, the present invention relates to an electronic component-sealing resin composition, an electronic component-sealing material, an electronic component, a varnish, an adhesive, a paste, and a product employing same.

### BACKGROUND ART

Ion scavengers are added to electronic component-sealing resins, electrical component-sealing resins, resins for electrical products, etc.

For example, many LSIs, ICs, hybrid ICs, transistors, diodes, thyristors, and hybrid components thereof are sealed using an epoxy resin. Such an electronic component-sealing material is required to prevent failure due to ionic impurities in a starting material or moisture entering from outside and to have various properties such as flame retardancy, high adhesion, crack resistance, and electrical properties such as high volume resistivity.

An epoxy resin, which is widely used as an electronic component-sealing material, comprises, in addition to a main component epoxy compound, an epoxy compound curing agent, a curing accelerator, an inorganic filler, a flame retardant, a pigment, a silane coupling agent, etc.

In recent years, because of concerns about the environment, there have been many cases in which environmentally burdensome substances such as heavy metals have not been used as a constituent of electronic component-sealing materials. Because of this, the use of antimony compounds, which have often been used conventionally, has been ended, and magnesium hydroxide is being used (ref. e.g. Patent Publication 1). Magnesium hydroxide decomposes at high temperature, and this endothermic reaction allows a flame retardant effect to be exhibited.

In order to prevent corrosion of aluminum wiring, etc. and enhance the reliability of electronic components, adding a hydrotalcite or a calcined material thereof, which are inorganic anion exchangers, to an epoxy resin, etc. has been proposed for the purpose of scavenging problematic impurity ions, in particular halogen ions (ref. e.g. Patent Publication 2, Patent Publication 3, Patent Publication 4, Patent Publication 5, and Patent Publication 6).

Furthermore, a semiconductor sealing epoxy resin composition to which a bismuth compound anion exchanger has been added is known (ref. e.g. Patent Publication 7). However, in commercial materials the compounds often contain nitrate ion and release the nitrate ion, and their use is limited. Furthermore, their use might also be limited from the viewpoint of recycling, etc. since an alloy with copper is easily formed.

(Patent Publication 1) JP-A-2005-320446 (JP-A denotes a Japanese unexamined patent application publication.)

### (Patent Publication 2) JP-A-63-252451

### (Patent Publication 3) JP-A-64-64243

### (Patent Publication 4) JP-A-60-40124

### (Patent Publication 5) JP-A-2000-226438

### (Patent Publication 6) JP-A-60-42418

### (Patent Publication 7) JP-A-02-294354

### DISCLOSURE OF INVENTION

### Problems to be Solved by the Invention

Since the conventionally used magnesium hydroxide sometimes contains sulfate ion, when it gradually decomposes in an electronic component-sealing material, sulfate ion is generated, and the sulfate ion thus generated corrodes aluminum wiring, etc., thus affecting the reliability of the electronic component (e.g. a semiconductor component) and causing a problem.

Furthermore, although the conventionally used hydrotalcites have the function of scavenging sulfate ion, many thereof contain sulfate ion in the same way as magnesium hydroxide, and instead they might release sulfate ion within a sealing resin, particularly at high temperature, thus making it impossible to use them.

Moreover, in a semiconductor sealing epoxy resin composition to which a bismuth compound anion exchanger has been added, commercial products have the function of scavenging sulfate ion, but as described above they release nitrate ion in exchange for the scavenged sulfate ion, and their use is limited. Furthermore, their use might also be limited from the viewpoint of recycling, etc. since an alloy with copper is easily formed.

Currently known high performance inorganic anion exchangers have the above-mentioned problems. It is an object of the present invention to provide a novel inorganic sulfate ion scavenger that is environmentally friendly and has high performance.

Furthermore, it is another object of the present invention to provide an inorganic scavenging composition comprising the inorganic sulfate ion scavenger.

It is yet another object of the present invention to provide an electronic component-sealing composition, an electronic component-sealing material, and an electronic component comprising the inorganic sulfate ion scavenger or the inorganic scavenging composition.

Furthermore, it is an object of the present invention to provide a varnish, an adhesive, or a paste comprising the inorganic sulfate ion scavenger or the inorganic scavenging composition, or a product comprising same.

### Means for Solving the Problems

As a result of an intensive investigation by the present inventors in order to find a novel inorganic anion exchanger that can be used in a semiconductor sealant, etc. in the electronics industry field, an inorganic sulfate ion scavenger from which little ionic impurities leach out has been found, and the present invention has thus been accomplished.

That is, the present invention is as follows.

(1) An inorganic sulfate ion scavenger for which the amount of ionic impurities leaching out in pure water is no greater than 500 ppm and the amount of sulfate ion leaching out in pure water is no greater than 30 ppm.

Method for measuring amount of ionic impurities leaching out from an inorganic sulfate ion scavenger into pure water: a sealable polytetrafluoroethylene pressure-resistant container was charged with 5 g of a sample (inorganic sulfate ion scavenger) and 50 mL of pure water, sealed, and treated at 125° C. for 20 hours. After cooling, this solution was filtered using a membrane filter having a pore size of 0.1 μm, the sulfate ion, nitrate ion, and chloride ion concentrations in the filtrate were measured by ion chromatography, and the sodium ion and magnesium ion concentrations were measured by ICP. The sum of all measurement values was multiplied by ten, and this numerical value was defined as the amount of ionic impurities (ppm).

Method for measuring amount of sulfate ion leaching out from an inorganic sulfate ion scavenger into pure water: a sealable polytetrafluoroethylene pressure-resistant container was charged with 5 g of a sample (inorganic sulfate ion scavenger) and 50 mL of pure water, sealed, and treated at 125° C. for 20 hours. After cooling, this solution was filtered using a membrane filter having a pore size of 0.1 μm, and sulfate ion in the filtrate was measured. This measurement value was multiplied by ten and defined as the amount of sulfate ion (ppm).

(2) The inorganic sulfate ion scavenger according to (1) above, wherein the sulfate ion exchange capacity is 0.5 to 10 meq/g.

Method for measuring sulfate ion exchange capacity of an inorganic sulfate ion scavenger: a polyethylene bottle was charged with 1 g of a sample (inorganic sulfate ion scavenger) and 50 mL of a 0.05 mol/L concentration sulfuric acid aqueous solution, hermetically sealed, and shaken at 40° C. for 24 hours. Subsequently, this solution was filtered using a membrane filter having a pore size of 0.1 μm, and the sulfate ion concentration of this filtrate was measured by ion chromatography. The sulfate ion exchange capacity (meq/g) of the inorganic sulfate ion scavenger was determined from the above measurement value and a value obtained by carrying out the same measurement procedure for sulfate ion concentration without putting in a sample.

(3) The inorganic sulfate ion scavenger according to (1) or (2) above, wherein the amount of sulfate radical contained in the inorganic sulfate ion scavenger is no greater than 3,000 ppm.

Method for measuring sulfate radical contained in an inorganic sulfate ion scavenger: after 0.5 g of a sample (inorganic sulfate ion scavenger) was dissolved in 5 mL of 35% nitric acid by boiling, it was neutralized, the sulfate ion concentration of this solution was measured by ion chromatography, and the sulfate radical content (ppm) in the inorganic sulfate ion scavenger was determined.

(4) The inorganic sulfate ion scavenger according to any one of (1) to (3), wherein the inorganic sulfate ion scavenger is selected from the group consisting of a hydrotalcite-like compound and a calcined material thereof, an aluminum compound, an yttrium compound, and zirconium oxide and a hydrate thereof.
(5) The inorganic sulfate ion scavenger according to any one of (1) to (4), wherein the inorganic sulfate ion scavenger is selected from the group consisting of a hydrotalcite-like compound and a calcined material thereof, an aluminum compound, and an yttrium compound.
(6) An inorganic scavenging composition comprising the inorganic sulfate ion scavenger according to any one of (1) to (5) above and an inorganic cation exchanger.
(7) An electronic component-sealing resin composition comprising the inorganic sulfate ion scavenger according to any one of (1) to (5) above or the inorganic scavenging composition according to (6) above.
(8) An electronic component-sealing material formed by curing the electronic component-sealing resin composition according to (7) above.
(9) An electronic component formed by sealing an element by means of the electronic component-sealing resin composition according to (7) above.
(10) A varnish comprising the inorganic sulfate ion scavenger according to any one of (1) to (5) above or the inorganic scavenging composition according to (6) above.
(11) A product comprising the varnish according to (10) above.
(12) An adhesive comprising the inorganic sulfate ion scavenger according to any one of (1) to (5) above or the inorganic scavenging composition according to (6) above.
(13) A product comprising the adhesive according to (12) above.
(14) A paste comprising the inorganic sulfate ion scavenger according to any one of (1) to (5) above or the inorganic scavenging composition according to Claim (6).
(15) A product comprising the paste according to (14) above.

### EFFECTS OF THE INVENTION

Adding the inorganic sulfate ion scavenger and the inorganic scavenging composition of the present invention to a resin enables the release of sulfate ion and ionic impurities from within the resin to be suppressed. Because of this, the inorganic sulfate ion scavenger or the inorganic scavenging composition of the present invention is used in sealing, covering, insulating, etc. an electronic component or an electrical component, thus enhancing the reliability thereof. Furthermore, the inorganic sulfate ion scavenger or the inorganic scavenging composition of the present invention may also be used in a stabilizer, an anticorrosive, etc. for a vinyl chloride, etc. resin.

Moreover, the inorganic sulfate ion scavenger or the inorganic scavenging composition of the present invention may be used suitably in a varnish, an adhesive, or a paste and, furthermore, they may be used suitably in a product comprising the varnish, the adhesive, or the paste.

### BEST MODE FOR CARRYING OUT THE INVENTION

### Inorganic Sulfate Ion Scavenger

With regard to the inorganic sulfate ion scavenger of the present invention, the amount of ionic impurities leaching out into pure water is no greater than 500 ppm, and the amount of sulfate ion leaching out into pure water is no greater than 30 ppm.

In the present invention, the inorganic sulfate ion scavenger is not particularly limited as long as the above-mentioned requirements are satisfied, and any material may be used. Specific examples thereof include a hydrotalcite-like compound and a calcined material thereof, an aluminum compound, zinc oxide and a hydrate thereof, bismuth oxide and a hydrate thereof, yttrium oxide and a hydrate thereof (these are called yttrium compounds), cerium oxide and a hydrate thereof, lanthanum oxide and a hydrate thereof, and zirconium oxide and a hydrate thereof. Among them, from the viewpoint of high performance in scavenging sulfate ion and good quality, a hydrotalcite-like compound and a calcined material thereof, an aluminum compound, an yttrium compound, and zirconium oxide and a hydrate thereof are preferred compounds, a hydrotalcite-like compound and a calcined material thereof, an aluminum compound, and an yttrium compound are more preferred compounds, and a hydrotalcite compound and a calcined material thereof, an aluminum compound, and an yttrium compound are yet more preferred compounds.

### Hydrotalcite-Like Compound

In the inorganic sulfate ion scavenger of the present invention, as the hydrotalcite-like compound, a layered compound represented by Formula (1) below can be cited.

M²⁺ₐM³⁺_{b}(OH)_{c}(A^{m-})_{d}.nH₂O (1)

In Formula (1), M²⁺ denotes a divalent metal, M³⁺ denotes a trivalent metal, A^{m-} denotes an m-valent anion such as carbonate ion or sulfate ion, and a, b, c, and d are positive numbers. Here, 2a+3b−c−md=0 is satisfied. Furthermore, n denotes a hydration number, and is 0 or a positive number.

Examples of the divalent metal (M²⁺) include Mg²⁺, Zn²⁺, Ni²⁺, and Mn²⁺, but are not limited thereto. Among them, as M²⁺, Mg²⁺, Zn²⁺, and Ni²⁺ are preferable, Mg²⁺ and Ni²⁺ are more preferable, and Mg²⁺ is yet more preferable.

Examples of the trivalent metal (M³⁺) include Al³⁺, Fe³⁺, Cr³⁺, and Co³⁺, but are not limited thereto. Among them, as M³⁺, Al³⁺ and Fe³⁺ are preferable, and Al³⁺ is more preferable.

Examples of the m-valent anion (A^{m-}) include sulfate ion (SO₄²⁻), nitrate ion (NO₃⁻), carbonate ion (CO₃²⁻), and a halogen ion (Cl⁻), but are not limited thereto. Among them, as the m-valent anion (A^{m-}), nitrate ion (NO₃²⁻) and carbonate ion (CO₃²⁻) are preferable, and carbonate ion (CO₃²⁻) is more preferable.

Furthermore, representative examples of Formula (1) include a magnesium aluminum hydrotalcite represented by the compositional formula Mg_{4.5}Al₂(OH)₁₃CO₃.3.5H₂O. However, the hydrotalcite-like compound of the present invention is not particularly limited in terms of the type and the ratio of the divalent metal and the trivalent metal as long as it has a hydrotalcite structure. a:b is preferably 3:2 to 10:2, more preferably 3.6:2 to 9:2, and yet more preferably 4:2 to 8:2.

Furthermore, c is preferably 10 to 24, more preferably 11.2 to 22, and yet more preferably 12 to 20.

Examples of the hydrotalcite-like compound used in the present invention include Mg_{4.5}Al₂(OH)₁₃CO₃.3.5H₂O, Zn_{4.5}Al₂(OH)₁₃CO₃.3.5H₂O, Ni_{4.5}Al₂(OH)₁₃CO₃.3.5H₂O, Mg_{4.5}Fe₂(OH)₁₃CO₃.3.5H₂O, Mg₅Al_{1.5}(OH)₁₃CO₃.3.5H₂O, and Mg₆Al₂(OH)₁₆CO₃.4H₂O.

Any starting material for obtaining the hydrotalcite-like compound in the present invention may be used as long as the hydrotalcite-like compound is obtained.

### Hydrotalcite Compound

In the inorganic sulfate ion scavenger of the present invention, among the above-mentioned hydrotalcite-like compounds, a magnesium aluminum hydrotalcite (called a hydrotalcite compound) is preferable. Any starting materials may be used as long as this hydrotalcite compound is obtained. For example, a substance obtained by dissolving magnesium sulfate and aluminum sulfate in water at a predetermined ratio, then forming a precipitate using a nitrate ion-containing alkali metal hydroxide, thermally aging this precipitate, and washing with water (production process involving a nitrate ion treatment) is preferable. With regard to the heating conditions when thermally aging, they are preferably 50° C. to 250° C., more preferably 70° C. to 230° C., and yet more preferably 90° C. to 210° C. It is preferable for the heating temperature to be in the above-mentioned range since crystallization occurs and ion-exchangeability becomes high. The thermal aging time is not particularly limited, and it is preferably 2 to 50 hours, more preferably 3 to 40 hours, and yet more preferably 4 to 30 hours. It is preferable for the thermal aging time to be in the above-mentioned range since the ion-exchangeability becomes good due to appropriate crystal growth.

As the hydrotalcite compound obtained by such a production process, that represented by the formula below can be cited as an example.

Mg_{4.5}Al₂(OH)₁₃CO₃.3.5H₂O

As the alkali metal hydroxide, sodium hydroxide and potassium hydroxide are preferable, and sodium hydroxide is more preferable.

Furthermore, as the inorganic sulfate ion scavenger of the present invention, a hydrotalcite compound prepared using a nitrate starting material is more preferable. The nitrate starting material is magnesium nitrate or a solution of magnesium hydroxide or magnesium oxide in nitric acid. It is also aluminum nitrate or a solution of aluminum hydroxide or aluminum oxide in nitric acid. A nitrate starting material may be used only for one thereof, but it is more preferable to use a nitrate starting material for both magnesium and aluminum.

That is, since the sulfate ion in the compound can be reduced, the hydrotalcite compound as the inorganic sulfate ion scavenger of the present invention is preferably one obtained by a production process involving a treatment with nitrate ion or one produced using a nitrate starting material, and is more preferably one produced using a nitrate starting material.

### Calcined Material of Hydrotalcite-Like Compound

In the inorganic sulfate ion scavenger of the present invention, the calcined material of the hydrotalcite-like compound may be obtained by calcining the above-mentioned hydrotalcite-like compound. The calcination temperature is preferably 350° C. to 1,000° C., more preferably 370° C. to 800° C., and particularly preferably 370° C. to 700° C. It is preferable for the calcination temperature to be at least 350° C. since good performance in scavenging sulfate ions is obtained. Furthermore, it is preferable for the calcination temperature to be no greater than 1,000° C. since the ion-exchangeability is not degraded.

Furthermore, the calcination time is not particularly limited, but it is preferably 2 to 24 hours, more preferably 3 to 20 hours, and particularly preferably 4 to 15 hours. It is preferable for the calcination time to be in the above-mentioned range since the ion-exchangeability is enhanced.

Examples of the calcined material of the hydrotalcite-like compound include Mg_{4.5}Al₂O_{7.5}, Mg_{0.7}Al_{0.3}O_{1.15}, Zn_{0.7}Al_{0.3}O_{1.15}, Ni_{0.7}Al_{0.3}O_{1.15}, Mg_{0.7}Fe_{0.3}O_{1.15}, Mg_{0.8}Al_{0.24}O_{1.16}, and Mg_{0.9}Al_{0.3}O_{1.35}. As the calcined material of the hydrotalcite-like compound, a calcined material of the hydrotalcite compound is preferable.

As the calcined material of the hydrotalcite compound, it is preferable to use one produced by calcining the above-mentioned hydrotalcite compound obtained by treatment with nitrate ion, or one produced by calcining a hydrotalcite compound obtained using a nitrate as a starting material, and it is more preferable to use one obtained using a nitrate as a starting material.

### Aluminum Compounds

In the inorganic sulfate ion scavenger of the present invention, any aluminum compounds may be used as long as they have the capability of scavenging sulfate ion. Examples of the aluminum compounds include an aluminum compound represented by Formula (2) below and amorphous alumina.

Al₂Oₓ(OH)_{y}(NO₃)_{z}.nH₂O (2)

In Formula (2), x is a positive number and preferably a positive number of no greater than 2.9, y is 0 or a positive number and preferably 0 or a positive number of no greater than 4.0, and z is 0 or a positive number of no greater than 3 and preferably 0 or a positive number of no greater than 1.0. They satisfy the equation 2x+y+z=6, n is 0 or a positive number, and it is more preferable that z is 0. That is, as the aluminum compound, one represented by Formula (3) below is preferable.

Al₂Oₓ(OH)_{y}.nH₂O (3)

In Formula (3), x and y are positive numbers, they satisfy the equation 2x+y=6, and n is 0 or a positive number.

### Aluminum Compound

Examples of the aluminum compound include Al₂O(OH)_{3.3}(NO₃)_{0.7}.H₂O, Al₂O₂(NO₃)₂, Al₂O_{0.5}(OH)₃(NO₃)₂, Al₂O(OH)₄, Al₂O(OH)₃(NO₃), Al₂O(OH)₂(NO₃)₂, Al₂O(OH)(NO₃)₃, Al₂O₂(OH)₂, Al₂O₂(OH)(NO₃), Al₂O₂(OH)_{0.5}(NO₃)_{1.5}, Al₂O(OH)_{3.7}(NO₃)_{0.3}.H₂O, Al₂O_{2.5}(NO₃), Al₂O_{2.8}(OH)_{0.3}(NO₃)_{0.1}, Al₂O_{2.7}(OH)_{0.4}(NO₃)_{0.2}, Al₂O₂(OH)_{1.4}(NO₃)_{0.6}.H₂O, Al₂O_{2.9}(OH)_{0.15}(NO₃)_{0.05}, Al₂O_{2.6}(OH)_{0.6}(NO₃)_{0.2}, Al₂O_{2.6}(OH)_{0.2}(NO₃)_{0.6}, Al₂O_{2.5}(OH)_{0.8}(NO₃)_{0.2}, Al₂O_{2.5}(OH)_{0.6}(NO₃)_{0.4}, Al₂O_{2.5}(OH)_{0.2}(NO₃)_{0.8}, Al₂O_{2.4}(OH)_{0.8}(NO₃)_{0.4}, Al₂O_{2.4}(OH)_{0.4}(NO₃)_{0.8}, Al₂O_{2.3}(OH)_{0.8}(NO₃)_{0.6}, Al₂O_{2.2}(OH)_{0.6}(NO₃), and Al₂O_{2.1}(OH)_{0.6}(NO₃)_{1.2}, and it is preferably Al₂O(OH)₄, Al₂O₂(OH)₂, etc.

In the present invention, any starting material for obtaining an aluminum compound represented by Formula (2) may be used as long as one having the above-mentioned properties can be obtained. For example, the aluminum compound may be obtained by forming a precipitate by neutralizing an aqueous solution of aluminum nitrate, drying this precipitate, and then calcining it, or directly calcining the precipitate. This precipitate may be subjected to an aging treatment. The aluminum compound may be obtained by directly heating aluminum nitrate and then calcining it. It is also possible to use as a starting material for the aluminum compound a solution of aluminum hydroxide, aluminum oxyhydroxide, aluminum oxide, metallic aluminum, etc. in nitric acid. That is, one obtained in this way may be used as aluminum nitrate, which is a starting material for the aluminum compound of the present invention.

The aluminum compound may be obtained by, for example, neutralizing an aqueous solution of aluminum nitrate at pH 3 to pH 12 to thus form a precipitate, drying, and then calcining this, or directly calcining. The pH is preferably pH 4 to 11, and more preferably pH 5 to 11. It is preferable for the pH of the aqueous solution to be at least 3 since a precipitate can be formed. It is also preferable for the pH of the aqueous solution to be no greater than 12 since an aluminum compound having good ion-exchangeability can be obtained.

The solution temperature at which the precipitate is formed from the aqueous solution is preferably 1° C. to 100° C., more preferably 10° C. to 80° C., and yet more preferably 20° C. to 60° C.

Preferred examples of a substance for adjusting the pH include an alkali metal hydroxide, an alkali metal carbonate, an alkali metal hydrogen carbonate, ammonia, and a compound that generates ammonia upon heating (e.g. urea, hexamethylenetetramine, etc.). As the alkali metal, sodium and potassium are preferable. More preferred examples of the substance for adjusting the pH include ammonia and a compound that generates ammonia upon heating.

The aluminum compound of the present invention may be obtained by aging the precipitate obtained by the above-mentioned procedure, and subsequently drying and calcining it, or directly calcining. This aging treatment may or may not be carried out, but it is preferably carried out. For example, the aging temperature is preferably 10° C. to 200° C., more preferably 15° C. to 120° C., and yet more preferably 20° C. to 100° C.

With regard to the aging time, the higher the temperature the shorter the heating time, and it is generally preferably 2 to 72 hours, more preferably 5 to 48 hours, and yet more preferably 10 to 30 hours.

Drying of the precipitate may be carried out at room temperature or by heating. That is, any treatment may be carried out as long as excess moisture can be removed from the precipitate. For example, the drying temperature for the precipitate in the present invention is preferably 80° C. to 250° C., and more preferably 100° C. to 200° C. This drying may be carried out at the same time as calcining. In this case, it is preferable that the temperature is set low until the moisture is removed, and subsequently it is raised to the calcination temperature.

The aluminum compound of the present invention may be obtained by drying the precipitate and then calcining it. The above-mentioned drying treatment may be carried out at the same time as this calcining.

A preferred calcination temperature depends on the calcination time. The calcination temperature is preferably 150° C. to 800° C., more preferably 200° C. to 650° C., and yet more preferably 300° C. to 600° C.

A preferred calcination time depends on the calcination temperature. The higher the temperature, the shorter the heating time, and the calcination time is generally preferably 1 to 72 hours, more preferably 2 to 48 hours, and yet more preferably 3 to 30 hours.

The aluminum compound in the present invention may also be obtained by directly heating aluminum nitrate and then calcining it.

The conditions for this direct heating treatment are preferably a heating time of 12 to 48 hours at a heating temperature of 140° C. to 200° C. The heating temperature is more preferably 150° C. to 190° C. It is preferable for the heating temperature to be in the above-mentioned range since an aluminum compound that can suitably be used in the present invention can be obtained.

The calcination conditions are preferably a time of 1 to 10 hours at a temperature of 350° C. to 650° C. The calcination temperature is more preferably 400° C. to 600° C. It is preferable for the calcination temperature to be in the above-mentioned range since an aluminum compound that can suitably be used in the present invention can be obtained.

That is, in the present invention, an aluminum compound may be obtained by neutralizing an aqueous solution of aluminum nitrate so as to form a precipitate, drying this precipitate at 80° C. to 250° C., and then calcining it at 150° C. to 800° C., or by directly calcining the precipitate at 150° C. to 800° C., or by directly heating aluminum nitrate at 140° C. to 200° C. and then calcining it at 350° C. to 650° C.

### Amorphous Alumina

The amorphous alumina in the present invention is an aluminum oxide whose crystal system is amorphous. The amorphous alumina is noncrystalline. This is a material that does not show a clear peak in X-ray diffraction analysis.

In the present invention, any starting material may be used for obtaining the amorphous alumina as long as this is obtained.

The amorphous alumina in the present invention may be obtained by, for example, adjusting an aqueous solution of aluminum nitrate so that it is basic, thus forming a precipitate, and drying and then heating this. The pH of the aqueous solution of aluminum nitrate is preferably pH 7.5 to 12, more preferably pH 8 to 11, and yet more preferably pH 8.5 to 11.

The temperature of the solution at which the precipitate is formed is preferably 1° C. to 100° C., more preferably 10° C. to 80° C., and yet more preferably 20° C. to 60° C.

Preferred examples of a substance for adjusting the pH include an alkali metal hydroxide, an alkali metal carbonate, an alkali metal hydrogen carbonate, ammonia, and a compound that generates ammonia upon heating (e.g. urea, hexamethylenetetramine, etc.). The alkali metal is preferably sodium or potassium. More preferred examples of the substance for adjusting the pH include ammonia and a compound that generates ammonia upon heating.

The amorphous alumina in the present invention may also be obtained by, for example, adjusting an aqueous solution of aluminum nitrate so that it is basic, thus forming a precipitate, thermally aging this, and subsequently drying it and carrying out a heating treatment. A preferred heating temperature for the thermal aging treatment depends on the heating time. For example, the heating temperature is preferably 100° C. to 300° C., more preferably 130° C. to 250° C., and yet more preferably 150° C. to 200° C.

A preferred thermal aging time depends on the heating temperature. The higher the temperature, the shorter the heating time, and the heating time is generally preferably 2 to 72 hours, more preferably 10 to 48 hours, and yet more preferably 20 to 30 hours.

Drying may be carried out at room temperature or by heating in a drying oven. That is, any treatment may be carried out as long as excess moisture can be removed from the precipitate. For example, the drying temperature in the present invention is preferably 80° C. to 250° C., and more preferably 110° C. to 200° C. This drying may be carried out at the same time as heating. In this case, it is preferable that the temperature is set low until the moisture is removed, and it is subsequently raised to the heating temperature.

The amorphous alumina in the present invention may be obtained by drying the above-mentioned precipitate and then heating it. The above-mentioned drying treatment and this heating treatment may be carried out at the same time.

A preferred heating temperature depends on the heating time. For example, the heating temperature is preferably 360° C. to 800° C., more preferably 380° C. to 700° C., and yet more preferably 400° C. to 600° C.

A preferred heating time depends on the heating temperature. The higher the temperature, the shorter the heating time, and the heating time is generally preferably 1.5 to 72 hours, more preferably 2 to 48 hours, and yet more preferably 3 to 30 hours.

### Yttrium Compounds

In the inorganic sulfate ion scavenger of the present invention, any yttrium compounds may be used as long as they have the capability of scavenging sulfate ion. Examples thereof include an yttrium compound represented by Formula (4) below.

Y₂Oₓ(OH)_{y}(NO₃)_{z}.nH₂O (4)

In Formula (4), x, y, and z are 0 or positive numbers, 2x+y+z=6, and n is 0 or a positive number.

x in Formula (4) is 0 or a positive number of no greater than 3, and preferably a positive number of no greater than 3.

y in Formula (4) is 0 or a positive number of no greater than 6, and preferably 0 or a positive number of no greater than 5.5.

z in Formula (4) is 0 or a positive number of no greater than 6, preferably 0 or a positive number of no greater than 4, and more preferably 0.

That is, the yttrium compound is preferably a compound represented by Formula (5) below.

Y₂Oₓ(OH)_{y}.nH₂O (5)

In Formula (5), x and y are 0 or positive numbers, 2x+y=6, and n is 0 or a positive number.

Specific examples of the yttrium compound in the present invention include Y₂O_{2.6}(OH)_{0.6}(NO₃)_{0.2}, Y₂(OH)_{5.1}(NO₃)_{0.9}.H₂O, Y₂O₂(NO₃)₂, Y₂O₃, Y₂(OH)₆, Y₂(OH)₄(NO₃)₂, Y₂(OH)₃(NO₃)₃, Y₂(OH)₂(NO₃)₄, Y₂(OH)(NO₃)₅, Y₂O(OH)₄, Y₂O(OH)₃(NO₃), Y₂O(OH)₂(NO₃)₂, Y₂O(OH)(NO₃)₃, Y₂O(NO₃)₄, Y₂O₂(OH)₂, Y₂O₂(OH)(NO₃), and Y₂O₂(NO₃)₂, and Y₂O₃, Y₂(OH)₆, Y₂O(OH)₄, Y₂O₂(OH)₂, etc., which do not contain nitrate ion, are preferable.

In the present invention, any starting material for obtaining the yttrium compound may be used as long as one represented by Formula (4) and having anion-exchangeability is obtained. For example, in the present invention the yttrium compound may be obtained by adjusting an aqueous solution of yttrium nitrate so that it is basic, thus forming a precipitate, drying this, and then heating it. It may, for example, be obtained by solubilizing yttrium oxide using nitric acid, and subjecting this to the above-mentioned treatments.

The yttrium compound in the present invention may be obtained by, for example, adjusting an aqueous solution of yttrium nitrate so that it is basic, thus forming a precipitate, drying this, and then heating it. The pH thereof is preferably pH 7.5 to 13, more preferably pH 8 to 11, and yet more preferably pH 8.5 to 10. The water temperature during this treatment is preferably 1° C. to 80° C., more preferably 10° C. to 60° C., and yet more preferably 15° C. to 40° C. Preferred examples of a substance for adjusting the pH include an alkali metal hydroxide, an alkali metal carbonate, an alkali metal hydrogen carbonate, ammonia, and a compound that generates ammonia upon heating (e.g. urea, hexamethylenetetramine, etc.). The alkali metal is preferably sodium or potassium. More preferred examples of the substance for adjusting the pH include ammonia and a compound that generates ammonia upon heating (e.g. urea, hexamethylenetetramine, etc.).

The yttrium compound in the present invention may also be obtained by, for example, adjusting an aqueous solution of yttrium nitrate so that it is basic, thus forming a precipitate, thermally aging this, subsequently drying it, and carrying out a heating treatment. A preferred heating temperature for the thermal aging treatment depends on the heating time. For example, the heating temperature is preferably 95° C. to 300° C., more preferably 130° C. to 250° C., and yet more preferably 150° C. to 200° C.

A preferred heating time for the thermal aging treatment depends on the heating temperature. The higher the temperature, the shorter the heating time, and it is generally preferably 2 to 72 hours, more preferably 10 to 48 hours, and yet more preferably 15 to 30 hours.

Drying may be carried out at room temperature or by heating in a drying oven. That is, any treatment may be carried out as long as excess moisture can be removed from the precipitate. For example, the drying temperature in the present invention is preferably 80° C. to 250° C., and more preferably 110° C. to 200° C. This drying may be carried out at the same time as heating. In this case, it is preferable that the temperature is set low until the moisture is removed, and it is subsequently raised to the heating temperature.

The yttrium compound in the present invention may be obtained by drying the precipitate and then heating it. A preferred heating temperature depends on the heating time. For example, the heating temperature is preferably 150° C. to 1,000° C., more preferably 180° C. to 900° C., and yet more preferably 200° C. to 850° C.

A preferred heating time in this heating treatment depends on the heating temperature. The higher the temperature, the shorter the heating time, and it is generally preferably 1 to 72 hours, more preferably 2 to 48 hours, and yet more preferably 3 to 30 hours.

The yttrium compound in the present invention, which is obtained as above, may be ground according to an intended application so as to have a desired particle size.

The particle size of the inorganic sulfate ion scavenger in the present invention is not particularly limited, but the average particle size is preferably 0.01 to 10 μm, and more preferably 0.05 to 3 μm. It is preferable for the particle size to be 0.01 to 10 μm since particles do not aggregate together and when added to a resin the physical properties are not impaired.

### Zirconium Oxide Hydrate

Zirconium oxide hydrate (hereinafter, also called ‘hydrated zirconium oxide’) may be crystalline or noncrystalline, and it is a compound synonymous with zirconium oxyhydroxide, zirconium hydroxide, hydrous zirconium oxide, and zirconium oxide hydrate. Examples of the hydrated zirconium oxide include Zr(OH)₄, ZrO(OH)₂.nH₂O, and ZrO₂.nH₂O.

The hydrated zirconium oxide in the present invention is a known compound, and the production process therefor is not particularly limited. As a preferred production process, there is a wet process, and the hydrated zirconium oxide may easily be obtained by hydrolyzing a zirconium-containing aqueous solution such as a zirconium oxychloride aqueous solution with water or an aqueous alkali solution.

### Zirconium Oxide

The zirconium oxide may be either crystalline or noncrystalline, but in order for high ion-exchangeability to be exhibited it is preferably noncrystalline. As the zirconium oxide in the present invention, a commercial product may be used as it is, or an anhydride formed by calcining the above-mentioned hydrated zirconium oxide may be used.

A preferred calcination temperature when obtaining noncrystalline zirconium oxide by calcining the hydrated zirconium oxide is 150° C. to 350° C.

### Amount of Ionic Impurities Leaching Out

The inorganic sulfate ion scavenger of the present invention contains little ionic impurities that leach out from the sulfate ion scavenger into water. In these ionic impurities, examples of anions include sulfate ion, nitrate ion, and chloride ion, and examples of cations include sodium ion and magnesium ion.

Method for measuring amount of ionic impurities leaching out from an inorganic sulfate ion scavenger into pure water: a sealable polytetrafluoroethylene pressure-resistant container is charged with 5 g of a sample (inorganic sulfate ion scavenger) and 50 mL of pure water, sealed, and treated at 125° C. for 20 hours. After cooling, this solution is filtered using a membrane filter having a pore size of 0.1 μm, the sulfate ion, nitrate ion, and chloride ion concentrations in the filtrate are measured by ion chromatography, and the sodium ion and magnesium ion concentrations are measured by ICP emission spectroscopy. The sum of all measurement values is multiplied by ten, and this numerical value is defined as the amount of ionic impurities (ppm).

Analysis conditions for ion chromatography and ICP emission spectroscopy are as follows.

### Ion Chromatography Analysis Conditions

Measurement equipment: model DX-300 manufactured by DIONEX
Separating column: IonPacAS4A-SC (manufactured by DIONEX)
Guard column: IonPac AG4A-SC (manufactured by DIONEX)
Eluent: 1.8 mM Na₂CO₃/1.7 mM NaHCO₃ aqueous solution
Flow rate: 1.5 mL/min
Suppressor: ASRS-1 (recycle mode)

Sulfate ion, nitrate ion, and chloride ion were measured under the above-mentioned analysis conditions.

### ICP Emission Spectroscopy

Sodium ion and magnesium ion concentrations were measured by an analytical method in accordance with JIS K 0116-2003.

In the present invention, the amount of ionic impurities leaching out from the inorganic sulfate ion scavenger is the sum of the amounts of the ions measured above. The amount of ionic impurities is no greater than 500 ppm, preferably no greater than 100 ppm, and more preferably no greater than 50 ppm. When the amount of ionic impurities exceeds 500 ppm, the reliability of an electronic material employing same cannot be maintained.

In the present invention, the lower limit for the amount of ionic impurities leaching out from the inorganic sulfate ion scavenger is not particularly limited, and is 0 ppm or above.

### Amount of Sulfate Ion Leaching Out

In the present invention, the amount of sulfate ion leaching out is the amount of sulfate ion leaching out from the inorganic sulfate ion scavenger into pure water.

Method for measuring amount of sulfate ion leaching out from an inorganic sulfate ion scavenger into pure water: a sealable polytetrafluoroethylene pressure-resistant container is charged with 5 g of a sample (inorganic sulfate ion scavenger) and 50 mL of pure water, sealed, and treated at 125° C. for 20 hours. After cooling, this solution is filtered using a membrane filter having a pore size of 0.1 μm, and the sulfate ion concentration of the filtrate is measured by ion chromatography, and the numerical value obtained by multiplying by 10 is defined as the sulfate ion concentration (ppm). Ion chromatography is carried out by the above-mentioned method.

In the present invention, the amount of sulfate ion leaching out from the inorganic sulfate ion scavenger into pure water is no greater than 30 ppm, preferably no greater than 10 ppm, and more preferably no greater than 5 ppm. When the amount of sulfate ion exceeds 30 ppm, the reliability of an electronic material employing same cannot be maintained.

Furthermore, the lower limit for the amount of sulfate ion leaching out from the inorganic sulfate ion scavenger into pure water is not particularly limited, and is 0 ppm or above.

### Sulfate Ion Exchange Capacity

In the present invention, the sulfate ion exchange capacity is measured using sulfuric acid.

Method for measuring sulfate ion exchange capacity of an inorganic sulfate ion scavenger: a polyethylene bottle is charged with 1 g of a sample (inorganic sulfate ion scavenger) and 50 mL of 0.05 mol/L concentration sulfuric acid aqueous solution, hermetically sealed, and shaken at 40° C. for 24 hours. Subsequently, this solution is filtered using a membrane filter having a pore size of 0.1 μm, and the sulfate ion concentration of this filtrate is measured by ion chromatography. The sulfate ion exchange capacity (meq/g) of the inorganic sulfate ion scavenger is determined from the above measurement value and a value obtained by carrying out the same measurement procedure for sulfate ion concentration without putting in a sample.

The sulfate ion exchange capacity of the inorganic sulfate ion scavenger of the present invention is preferably at least 0.5 meq/g, more preferably at least 0.7 meq/g, and yet more preferably at least 0.8 meq/g. Moreover, the sulfate ion exchange amount of the inorganic sulfate ion scavenger is preferably no greater than 10 meq/g, more preferably no greater than 8 meq/g, and yet more preferably no greater than 6 meq/g. It is preferable for the sulfate ion exchange capacity to be in this range since the reliability of an electronic material employing same can be maintained.

### Amount of Sulfate Radical Contained in Inorganic Sulfate Ion Scavenger

In the present invention, the amount of sulfate radical contained in the inorganic sulfate ion scavenger is the concentration of sulfate ion contained in the inorganic sulfate ion scavenger.

Method for measuring amount of sulfate radical contained in an inorganic sulfate ion scavenger: after 0.5 g of a sample (inorganic sulfate ion scavenger) is dissolved in 5 mL of 35% nitric acid by boiling, it is neutralized, the sulfate ion concentration of this solution is measured by ion chromatography, and the sulfate radical content (ppm) is determined. Ion chromatography is carried out by the above-mentioned method.

The concentration of sulfate radical contained in the inorganic sulfate ion scavenger in the present invention is preferably no greater than 3,000 ppm, more preferably no greater than 1,000 ppm, and yet more preferably no greater than 500 ppm. It is preferable for the sulfate radical content to be in this range since the reliability of an electronic material can be maintained. The lower limit for the concentration of sulfuric acid contained in the inorganic sulfate ion scavenger is not particularly limited and is 0 ppm or above.

### Electrical Conductivity

The electrical conductivity of a supernatant from the inorganic sulfate ion scavenger of the present invention is preferably no greater than 200 μS/cm, more preferably no greater than 150 μS/cm, and yet more preferably no greater than 100 μS/cm. The lower limit for the electrical conductivity of the supernatant from the inorganic sulfate ion scavenger is not particularly limited, and is 0 μS/cm or above.

It is preferable for the electrical conductivity of the supernatant to be no greater than 200 μS/cm since the reliability of an electronic material employing same can be maintained.

Method for measuring electrical conductivity of supernatant: 5 g of an inorganic sulfate ion scavenger is placed in 50 g of pure water, treated at 125° C. for 20 hours, and filtered, and the electrical conductivity of the supernatant is measured using an electrical conductivity meter.

In summary, with regard to the inorganic sulfate ion scavenger of the present invention, ionic impurities are no greater than 500 ppm, the amount of sulfate ion leaching out is no greater than 30 ppm, the content of sulfate radical is preferably no greater than 3,000 ppm, the sulfate ion exchange capacity is preferably 0.5 to 10 meq/g, and the electrical conductivity of the supernatant is preferably no greater than 200 μS/cm.

### Inorganic Scavenging Composition

In accordance with use of the inorganic sulfate ion scavenger of the present invention in combination with an inorganic cation exchanger, the performance in scavenging sulfate ion by the inorganic sulfate ion scavenger of the present invention can be enhanced, and an effect in scavenging cationic ions can also be increased. In the present invention, the inorganic scavenging composition is a mixture of at least the inorganic sulfate ion scavenger of the present invention and an inorganic cation exchanger.

In the present invention, with regard to the inorganic cation exchanger, any inorganic substance having cation-exchangeability may be used as long as the performance of the inorganic sulfate ion scavenger is not impaired.

In the inorganic scavenging composition of the present invention, the mixing ratio of the inorganic sulfate ion scavenger and the inorganic cation exchanger is not particularly limited. For example, relative to 100 parts by weight of the inorganic sulfate ion scavenger, the inorganic cation exchanger is preferably no greater than 400 parts by weight, and more preferably no greater than 100 parts by weight. It is also preferably at least 10 parts by weight, and more preferably at least 20 parts by weight.

It is preferable for the mixing ratio of the inorganic sulfate ion scavenger and the inorganic cation exchanger to be in the above-mentioned range since good performance in scavenging sulfate ion is obtained.

Addition of the inorganic sulfate ion scavenger of the present invention and the inorganic cation exchanger may be carried out individually when preparing an electronic component-sealing resin composition, or they may be uniformly mixed in advance. It is preferable to use an inorganic scavenging composition in which the inorganic sulfate ion scavenger and the inorganic cation exchanger are mixed in advance. It is preferable to do so since the effect thereof can be further exhibited.

In the present invention, specific examples of the inorganic cation exchanger include hydrated oxides of a pentavalent metal, represented by antimonic acid (antimony pentaoxide hydrate), niobic acid (niobium pentaoxide hydrate), and tantalic acid, manganese oxide, insoluble tetravalent metal phosphates represented by titanium phosphate, tin phosphate, cerium phosphate, and zirconium phosphate, zeolites, thallic acid, molybdic acid, tungstic acid, and clay minerals, and antimonic acid (antimony pentaoxide hydrate), zirconium phosphate, and titanium phosphate are preferable.

Electronic Component-Sealing Resin Composition

With regard to a resin used in an electronic component-sealing resin composition comprising the inorganic sulfate ion scavenger or the inorganic scavenging composition of the present invention, it may be either a thermosetting resin such as a phenolic resin, a urea resin, a melamine resin, an unsaturated polyester resin, or an epoxy resin, or a thermoplastic resin such as polyethylene, polystyrene, vinyl chloride, or polypropylene, and a thermosetting resin is preferable. As the thermosetting resin used in the electronic component-sealing resin composition of the present invention, a phenolic resin or an epoxy resin is preferable, and an epoxy resin is particularly preferable.

The epoxy resin may be used without limitation as long as it is used as an electronic component-sealing resin. For example, the type thereof is not limited as long as it has at least two epoxy groups per molecule and is curable, and any resin used as a molding material, such as a phenol.novolac type epoxy resin, a bisphenol A type epoxy resin, or an alicyclic epoxy resin, may be used. Furthermore, in order to enhance the moisture resistance of the composition of the present invention, it is preferable to use, as the epoxy resin, one having a chloride ion content of no greater than 10 ppm and a hydrolyzable chlorine content of no greater than 1,000 ppm.

The chloride ion content in the epoxy resin is preferably no greater than 7 ppm, and more preferably no greater than 5 ppm.

Method for measuring chloride ion content: the chloride ion content in an epoxy resin may be measured by grinding a cured resin, adding 25.0 g of pure water to 2.5 g of the ground material, carrying out a boiling and extraction treatment for 20 hours, cooling it, and then measuring the Cl content of the supernatant by ion chromatography, etc.

The hydrolyzable chlorine content in the epoxy resin is preferably no greater than 500 ppm, and more preferably no greater than 100 ppm.

Measurement of hydrolyzable chlorine content in epoxy resin: the content may be measured by grinding a cured resin, adding 25.0 g of a 1N KOH aqueous solution to 2.5 g of the ground material, and carrying out an extraction treatment at 125° C. for 20 hours in a sealed state in a Teflon (registered trademark) container, etc., cooling it, and then measuring the Cl content of the supernatant by ion chromatography, etc.

In the present invention, it is preferable for the electronic component-sealing epoxy resin composition to comprise a curing agent and a curing accelerator.

As the curing agent used in the present invention, any substance known as a curing agent for an epoxy resin composition may be used, and preferred specific examples thereof include an acid anhydride, an amine type curing agent, and a novolac type curing agent.

As the curing accelerator used in the present invention, any substance known as a curing accelerator for an epoxy resin composition may be used, and preferred specific examples thereof include amine type, phosphorus type, and imidazole type accelerators.

The electronic component-sealing resin composition of the present invention may comprise as necessary a component known as one added to a molding resin. Examples of this component include an inorganic filler, a flame retardant, a coupling agent for an inorganic filler, a colorant, and a mold release agent. All of these components are known as components added to a molding epoxy resin. Preferred specific examples of the inorganic filler include crystalline silica powder, quartz glass powder, fused silica powder, alumina powder, and talc, and among them crystalline silica powder, quartz glass powder, and fused silica powder are preferable since they are inexpensive. Examples of the flame retardant include antimony oxide, a halogenated epoxy resin, magnesium hydroxide, aluminum hydroxide, a red phosphorus type compound, and a phosphoric acid ester type compound, examples of the coupling agent include silane types and titanium types, and examples of the mold release agent include waxes such as an aliphatic paraffin and a higher fatty alcohol.

The electronic component-sealing resin composition comprising the inorganic sulfate ion scavenger or the inorganic scavenging composition of the present invention exhibits its effect particularly effectively when it is exposed to a high temperature of 100° C. or higher. That is, an electronic component-sealing resin composition or various types of additives contained therein readily release sulfate ion when exposed to high temperature, thus causing the reliability to deteriorate. With respect to an electronic component-sealing resin composition for which the temperature is 100° C. or higher, and particularly 150° C. or higher, the inorganic sulfate ion scavenger or the inorganic scavenging composition of the present invention acts effectively.

With regard to the electronic component-sealing resin composition to which the inorganic sulfate ion scavenger or the inorganic scavenging composition of the present invention is added, the amount of sulfate ion leaching out into pure water from a resin obtained by curing the composition is 50 ppm or above but no greater than 5,000 ppm, and more preferably 80 ppm or above but no greater than 1,000 ppm. It is preferable for the amount of sulfate ion leaching out to be no greater than 5,000 ppm since the amount of inorganic sulfate ion scavenger or inorganic scavenging composition that needs to be added is appropriate and the physical properties of an electronic component sealant are not adversely affected.

A method for measuring the amount of sulfate ion leaching out involves placing 5 g of a cured resin in 50 g of pure water, treating it at 125° C. for 20 hours, then filtering, measuring the amount of sulfate ion leaching out into the supernatant, and multiplying the measurement value by 10. Measurement of the amount of sulfate ion in the supernatant is carried out by ion chromatography.

An electronic component-sealing resin composition to which the inorganic sulfate ion scavenger or the inorganic scavenging composition of the present invention is added is cured, and the amount of sulfate ion leaching out into pure water from the cured resin kneaded material is preferably no greater than 50 ppm, more preferably no greater than 30 ppm, and yet more preferably no greater than 25 ppm. The lower limit for the amount of sulfate ion leaching out is not particularly limited; it is 0 ppm or above, and the amount of sulfate ion leaching out is preferably 0.1 ppm or above.

The inorganic sulfate ion scavenger or the inorganic scavenging composition of the present invention may be used particularly effectively in an electronic component-sealing resin composition employing magnesium hydroxide as a flame retardant. Magnesium hydroxide decomposes at high temperature and this endothermic reaction allows a flame retardant effect to be exhibited. However, since commercially available magnesium hydroxide contains sulfate ion, this sulfate ion gradually leaching out in an epoxy resin corrodes aluminum wiring, etc., thus affecting the reliability of an electronic component (e.g. a semiconductor component) and causing a problem. Therefore, in order to scavenge sulfate ion generated from magnesium hydroxide and maintain the reliability, the inorganic sulfate ion scavenger or the inorganic scavenging composition of the present invention is suitable.

Other than the above-mentioned components, a reactive diluent, a solvent, a thixotropy-imparting agent, etc. may be added. Specific examples of the reactive diluent include butylphenyl glycidyl ether, specific examples of the solvent include methyl ethyl ketone, and specific examples of the thixotropy-imparting agent include an organically modified bentonite.

With regard to the mixing proportion of the inorganic sulfate ion scavenger or the inorganic scavenging composition of the present invention, it is preferably 0.1 to 10 parts by weight relative to 100 parts by weight of the electronic component-sealing resin composition, and more preferably 1 to 5 parts by weight. It is preferable for the mixing proportion to be at least 0.1 parts by weight since there is an effect in enhancing removal of sulfate ion. It is also preferable for it to be no greater than 10 parts by weight since the removal of sulfate ion is sufficient and the economics are good.

The electronic component-sealing resin composition of the present invention can easily be obtained by mixing the above-mentioned starting materials by a known method, and is obtained by, for example, appropriately mixing each of the above-mentioned starting materials, kneading this mixture in a heated state by a kneader to give a partially cured resin composition, cooling this to room temperature, then grinding it by known means, and tabletting as necessary.

The inorganic sulfate ion scavenger or the inorganic scavenging composition of the present invention may be used in various applications such as sealing, covering, insulation, etc. of an electronic component or an electrical component.

Furthermore, the inorganic sulfate ion scavenger or the inorganic scavenging composition of the present invention may also be used in a stabilizer, a corrosion inhibitor, etc. for a vinyl chloride, etc. resin.

A resin composition for an electronic component to which the inorganic sulfate ion scavenger or the inorganic scavenging composition of the present invention is added may be used in a support member such as a lead frame, a wired tape carrier, a wiring board, a glass, or a silicon wafer, one equipped with elements such as active elements such as a semiconductor chip, a transistor, a diode, or a thyristor, and passive elements such as a condenser, a resistor, or a coil. The electronic component-sealing resin composition of the present invention may also be used effectively in a printed circuit board. The electronic component-sealing epoxy resin composition to which the inorganic sulfate ion scavenger or the inorganic scavenging composition of the present invention is added is also used in the same manner.

As a method for sealing an element using the electronic component-sealing resin composition or the electronic component-sealing epoxy resin composition of the present invention, a low pressure transfer molding method is the most common, but an injection molding method, a compression molding method, etc. may also be used.

### Application to Wiring Board

A wiring board is produced by forming a printed wiring substrate utilizing the thermosetting properties of an epoxy resin, etc., adhering a copper foil, etc. thereto, and forming a circuit by etching, etc. However, in recent years there have been problems with corrosion and poor insulation due to an increase in density of the circuit, layering of circuits, making an insulating layer film thinner, etc. Such corrosion can be prevented by adding the inorganic sulfate ion scavenger or the inorganic scavenging composition of the present invention when forming a wiring board. Furthermore, corrosion, etc. of a wiring board can be prevented by adding the inorganic sulfate ion scavenger or the inorganic scavenging composition of the present invention to an insulating layer for a wiring board. From such viewpoints, a wiring board comprising the inorganic sulfate ion scavenger or the inorganic scavenging composition of the present invention can suppress the occurrence of defective products due to corrosion, etc. It is preferable to add 0.05 to 5 parts by weight of the inorganic sulfate ion scavenger or the inorganic scavenging composition of the present invention relative to 100 parts by weight of resin solids content of a wiring board or an insulating layer for a wiring board. It is more preferable to add 0.15 to 3.0 parts by weight, and it is yet more preferable to add 0.2 to 2.0 parts by weight.

It is preferable for the amount of inorganic sulfate ion scavenger or inorganic scavenging composition added to be in the above-mentioned range since the reliability of a product employing same is good.

### Addition to Adhesive

Electronic components, etc. are mounted on a substrate such as a wiring board using an adhesive. By adding the inorganic sulfate ion scavenger or the inorganic scavenging composition of the present invention to this adhesive, the occurrence of defective products due to corrosion, etc. can be suppressed, and the inorganic sulfate ion scavenger or the inorganic scavenging composition of the present invention can therefore be used suitably. It is preferable to add 0.05 to 5 parts by weight of the inorganic sulfate ion scavenger or the inorganic scavenging composition of the present invention relative to 100 parts by weight of resin solids content of the adhesive. It is more preferable to add 0.15 to 3.0 parts by weight, and it is yet more preferable to add 0.2 to 2.0 parts by weight. It is preferable for the amount added to be in the above-mentioned range since the reliability of a product employing same is good.

Moreover, by adding the inorganic sulfate ion scavenger or the inorganic scavenging composition of the present invention to a conductive adhesive, etc. used when wiring or connecting an electronic component, etc. to a wiring board, defects due to corrosion, etc. can be suppressed. Examples of the conductive adhesive include one containing a conductive metal such as silver. It is preferable to add 0.05 to 5 parts by weight of the inorganic sulfate ion scavenger or the inorganic scavenging composition of the present invention relative to 100 parts by weight of resin solids content of the conductive adhesive. It is more preferable to add 0.15 to 3.0 parts by weight, and it is yet more preferable to add 0.2 to 2.0 parts by weight. It is preferable for the amount added to be in the above-mentioned range since the reliability of a product employing same is good.

### Addition to Varnish

An electrical product, a printed wiring board, an electronic component, etc. may be formed using a varnish comprising the inorganic sulfate ion scavenger or the inorganic scavenging composition of the present invention. Examples of the varnish include one containing as a main component a thermosetting resin such as an epoxy resin. It is preferable to add 0.05 to 5 parts by weight of the inorganic sulfate ion scavenger or the inorganic scavenging composition of the present invention relative to 100 parts by weight of the resin solids content. It is more preferable to add 0.15 to 3.0 parts by weight, and it is yet more preferable to add 0.2 to 2.0 parts by weight. It is preferable for the amount added to be in the above-mentioned range since the reliability of a product employing same is good.

### Addition to Paste

The inorganic sulfate ion scavenger or the inorganic scavenging composition of the present invention may be added to a paste containing silver powder, etc. The paste is used as an adjuvant for soldering, etc. in order to improve adhesion between metals that are to be connected. This enables the occurrence of a corrosive substance generated from the paste to be suppressed. It is preferable to add of 0.05 to 5 parts by weight of the inorganic sulfate ion scavenger or the inorganic scavenging composition of the present invention relative to 100 parts by weight of resin solids content of the paste. It is more preferable to add 0.15 to 0.2 parts by weight, and it is yet more preferable to add 0.2 to 2.0 parts by weight. It is preferable for the amount added to be in the above-mentioned range since the reliability of a product employing same is good.

### Embodiments

An inorganic sulfate ion scavenger, wherein in an inorganic scavenger for sulfate ion, the amount of ionic impurities leaching out into pure water is no greater than 500 ppm and the amount of sulfate ion leaching out into pure water is no greater than 30 ppm, and the sulfate ion exchange capacity is preferably 10 to 0.5 meq/g.

A hydrotalcite compound, wherein in an inorganic scavenger for sulfate ion, the amount of ionic impurities leaching out into pure water is no greater than 500 ppm, the amount of sulfate ion leaching out into pure water is no greater than 30 ppm, and the sulfate ion exchange capacity is preferably 10 to 0.5 meq/g.

A hydrotalcite calcined material, wherein in an inorganic scavenger for sulfate ion, the amount of ionic impurities leaching out into pure water is no greater than 500 ppm and the amount of sulfate ion leaching out into pure water is no greater than 30 ppm, and the sulfate ion exchange capacity is preferably 10 to 0.5 meq/g.

A hydrotalcite compound or a hydrotalcite calcined material obtained using a production process involving a nitrate ion treatment, wherein in an inorganic scavenger for sulfate ion, the amount of ionic impurities leaching out into pure water is no greater than 500 ppm and the amount of sulfate ion leaching out into pure water is no greater than 30 ppm, and the sulfate ion exchange capacity is preferably 10 to 0.5 meq/g.

A hydrotalcite compound a hydrotalcite calcined material produced using a nitrate starting material, wherein in an inorganic scavenger for sulfate ion, the amount of ionic impurities leaching out into pure water is no greater than 500 ppm and the amount of sulfate ion leaching out into pure water is no greater than 30 ppm, and the sulfate ion exchange capacity is preferably 10 to 0.5 meq/g.

An aluminum compound, wherein in an inorganic scavenger for sulfate ion, the amount of ionic impurities leaching out into pure water is no greater than 500 ppm and the amount of sulfate ion leaching out into pure water is no greater than 30 ppm, and the sulfate ion exchange capacity is preferably 10 to 0.5 meq/g.

An aluminum compound produced using a nitrate starting material, wherein in an inorganic scavenger for sulfate ion, the amount of ionic impurities leaching out into pure water is no greater than 500 ppm and the amount of sulfate ion leaching out into pure water is no greater than 30 ppm, and the sulfate ion exchange capacity is preferably 10 to 0.5 meq/g.

An yttrium compound, wherein in an inorganic scavenger for sulfate ion, the amount of ionic impurities leaching out into pure water is no greater than 500 ppm and the amount of sulfate ion leaching out into pure water is no greater than 30 ppm, and the sulfate ion exchange capacity is preferably 10 to 0.5 meq/g.

An yttrium compound produced using a nitrate starting material, wherein in an inorganic scavenger for sulfate ion, the amount of ionic impurities leaching out into pure water is no greater than 500 ppm and the amount of sulfate ion leaching out into pure water is no greater than 30 ppm, and the sulfate ion exchange capacity is preferably 10 to 0.5 meq/g.

### EXAMPLES

The present invention is explained in further detail below by reference to Examples and Comparative Examples, but the present invention is not limited thereto. Furthermore, % denotes wt %, ppm denotes wt ppm, and parts denotes parts by weight.

### Example 1

134.6 g of magnesium nitrate hexahydrate and 93.8 g of aluminum nitrate nonahydrate were dissolved in 200 mL of pure water, and while maintaining this solution at 25° C. the pH was adjusted to 10.3 with a solution of 97.4 g of sodium carbonate and 160 g of sodium hydroxide in 1 L of pure water. It was aged at 98° C. for 24 hours. After cooling, a precipitate was washed with pure water, thus giving hydrotalcite compound 1 (inorganic sulfate ion scavenger A1). When an analysis was carried out on this compound, it was found to be Mg_{4.5}Al₂(OH)₁₃CO₃.3.5H₂O.

### Example 2

The hydrotalcite compound 1 prepared in Example 1 was heated at 550° C. for 6 hours. It was subsequently ground, thus giving a calcined material of the hydrotalcite compound (inorganic sulfate ion scavenger A2). When an analysis was carried out on this compound, it was found to be Mg_{4.5}Al₂O_{7.5}.

### Example 3

10 g of aluminum nitrate was dissolved in 100 mL of pure water, and while maintaining this solution at 25° C. the pH was adjusted to 11 with an aqueous ammonia solution. After stirring for 1 hour, a precipitate was filtered and washed with pure water. This precipitate was placed in a dryer and dried at 120° C. for 24 hours. Subsequently, it was calcined at 500° C. for 6 hours, cooled, and then ground, thus giving aluminum compound 1 (inorganic sulfate ion scavenger B1). When an analysis was carried out on this compound, it was found to be amorphous Al₂O₃.nH₂O.

### Example 4

10 g of aluminum nitrate was dissolved in 100 mL of pure water, and while maintaining this solution at 25° C. the pH was adjusted to 9 with an aqueous ammonia solution. After stirring this solution for 1 hour, it was placed in a sealable polytetrafluoroethylene container, and heated at 180° C. for 24 hours. Subsequently, it was allowed to cool to room temperature, and a precipitate was filtered and washed with pure water.

The precipitate thus washed was placed in a dryer, heated at 200° C. for 24 hours, and then heated at 500° C. for 4 hours. Following this it was ground, thus giving aluminum compound 2 (inorganic sulfate ion scavenger B2). When an analysis was carried out on this compound, it was found to be amorphous Al₂O₃.

### Example 5

The washed precipitate prepared in Example 4 was placed in a dryer, heated at 200° C. for 24 hours, and then heated at 400° C. for 4 hours. Following this it was ground, thus giving aluminum compound 3 (inorganic sulfate ion scavenger B3). When an analysis was carried out on this compound, it was found to be amorphous Al₂O₃.

### Example 6

10 g of aluminum nitrate was dissolved in 100 mL of pure water, and while maintaining this solution at 25° C. the pH was adjusted to 9 with an aqueous ammonia solution. After stirring for 1 hour, a precipitate was filtered and washed with pure water. This precipitate was placed in a dryer and treated at 200° C. for 24 hours. This was further heated at 500° C. for 4 hours. It was subsequently ground, thus giving aluminum compound 4 (inorganic sulfate ion scavenger B4). When an analysis was carried out on this compound, it was found to be amorphous Al₂O₃.

### Example 7

10 g of yttrium nitrate was dissolved in 100 mL of pure water; while maintaining the solution at 25° C. the pH was adjusted to 12.5 with a 10% sodium hydroxide solution, and it was refluxed and aged at 98° C. for 24 hours. After cooling, a precipitate was filtered and washed with pure water. This precipitate was dried at 120° C. for 24 hours, then calcined at 550° C. for 6 hours, cooled, and then ground, thus giving yttrium compound 1 (inorganic sulfate ion scavenger C1). When an analysis was carried out on this compound, it was found to be Y₂O_{2.6}(OH)_{0.6}(NO₃)_{0.2}.

### Example 8

10 g of yttrium nitrate was dissolved in 100 mL of pure water, and while maintaining the solution at 25° C. the pH was adjusted to 9 with an aqueous ammonia solution. This solution was stirred for 1 hour, and a precipitate was then filtered and washed with pure water.

This precipitate was placed in a dryer and heated at 200° C. for 24 hours. It was subsequently ground, thus giving yttrium compound 2 (inorganic sulfate ion scavenger C2). When an analysis was carried out on this compound 1, it was found to be Y₂(OH)_{5.1}(NO₃)_{0.9}.H₂O.

### Example 9

Yttrium compound 1 synthesized in Example 8 was further heated at 400° C. for 4 hours, thus giving yttrium compound 3 (inorganic sulfate ion scavenger C3). When an analysis was carried out on this compound, it was found to be Y₂O₂(NO₃)₂.

### Example 10

10 g of yttrium nitrate was dissolved in 100 mL of pure water, and while maintaining this solution at 25° C. the pH was adjusted to 9 with an aqueous ammonia solution. After stirring this solution for 1 hour, it was placed in a sealable polytetrafluoroethylene container, and heated at 180° C. for 24 hours. Subsequently, it was allowed to cool to room temperature, and a precipitate was filtered and washed with pure water.

This was placed in a dryer, heated at 200° C. for 24 hours, and further heated at 500° C. for 4 hours. It was subsequently ground, thus giving yttrium compound 4 (inorganic sulfate ion scavenger C4). When an analysis was carried out on this compound, it was found to be Y₂O₃.

### Comparative Example 1

A commercial hydrotalcite compound DHT-4A manufactured by Kyowa Chemical Industry Co., Ltd was used as comparative compound 1. The chemical formula thereof is Mg_{4.3}Al₂(OH)_{12.6}CO₃.mH₂O.

### Comparative Example 2

Bismuth nitrate oxide hydrate, which is an anion exchanger, was used as comparative compound 2. The chemical formula thereof is Bi₆O₆(OH)_{4.2}(NO₃)_{1.8},H₂O.

### Comparative Example 3

Reagent grade α-alumina was used as comparative compound 3. The chemical formula thereof is Al₂O₃.

### Basic Physical Properties of Inorganic Sulfate Ion Scavenger

### Measurement of Sulfate Ion Exchange Capacity

1.0 g of inorganic sulfate ion scavenger A1 was placed in a 100 mL polyethylene bottle, 50 mL of a 0.05 mol/L concentration sulfuric acid aqueous solution was further added thereto, and the bottle was sealed and shaken at 40° C. for 24 hours. Subsequently, this solution was filtered using a membrane filter having a pore size of 0.1 μm, and the sulfate ion concentration of the filtrate was measured by ion chromatography. The sulfate ion exchange capacity (meq/g) was determined by dividing this sulfate ion value by a value obtained by measuring sulfate ion concentration when the same procedure was carried out without putting in the inorganic sulfate ion scavenger. The result is given in Table 1.

Inorganic sulfate ion scavengers A2, B1 to B4, and C1 to C4 and comparative compounds 1 to 3 were also treated in the same manner, and sulfate ion exchange capacities (meq/g) were determined. These results are given in Table 1.

### Ion Chromatography Analysis Conditions

Measurement equipment: model DX-300 manufactured by DIONEX
Separating column: IonPac AS4A-SC (manufactured by DIONEX)
Guard column: IonPacAG4A-SC (manufactured by DIONEX)
Eluent: 1.8 mM Na₂CO₃/1.7 mM NaHCO₃ aqueous solution
Flow rate: 1.5 mL/min
Suppressor: ASRS-1 (recycle mode)

Sulfate ion was measured under the above-mentioned analysis conditions.

Amount of Sulfate Ion Leaching Out from Inorganic Sulfate Ion Scavenger

5.0 g of inorganic sulfate ion scavenger A1 was placed in a 100 mL sealable polytetrafluoroethylene pressure-resistant container, 50 mL of pure water was further added thereto, and the container was sealed and treated at 125° C. for 20 hours. After cooling, this solution was filtered using a membrane filter having a pore size of 0.1 μm, the sulfate ion concentration of the filtrate was measured by ion chromatography (above-mentioned conditions), and the numerical value obtained by multiplying by 10 was defined as the amount (ppm) of sulfate ion leaching out from inorganic sulfate ion scavenger A1. The result is given in Table 1.

Inorganic sulfate ion scavengers A2, B1 to B4, and C1 to C4 and comparative compounds 1 to 3 were treated in the same manner, and the amounts (ppm) of sulfate ion leaching out were measured. These results are given in Table 1.

Amount of ionic impurities leaching out from inorganic sulfate ion scavenger 5.0 g of inorganic sulfate ion scavenger A1 was placed in a 100 mL sealable polytetrafluoroethylene pressure-resistant container, 50 mL of pure water was further added thereto, and the container was sealed and treated at 125° C. for 20 hours. After cooling, this solution was filtered using a membrane filter having a pore size of 0.1 μm, and sulfate ion, nitrate ion, and chloride ion concentrations of the filtrate were measured by ion chromatography (under the above-mentioned analysis conditions; in addition to sulfate ion, nitrate ion and chloride ion were measured. The same applies below). Furthermore, sodium ion and magnesium ion concentrations of the filtrate were measured by ICP. The numerical value obtained by multiplying the sum of the measurement values by 10 was defined as the amount of ionic impurities (ppm). The result is given in Table 1.

Inorganic sulfate ion scavengers A2, B1 to B4, and C1 to C4 and comparative compounds 1 to 3 were treated in the same manner, and the amounts of ionic impurities (ppm) were measured. These results are given in Table 1.

### ICP Emission Spectroscopy

Sodium ion and magnesium ion concentrations were measured by an analytical method in accordance with JIS K 0116-2003.

### Measurement of Sulfate Radical Content of Inorganic Sulfate Ion Scavenger

0.5 g of inorganic sulfate ion scavenger A1 was placed in a platinum crucible, 5 mL of 35% nitric acid was added thereto, and it was dissolved by boiling. The solution after the treatment was made up to 100 mL, and the sulfate ion concentration of this solution was measured by ion chromatography. The content (ppm) of sulfate radical in inorganic sulfate ion scavenger 1 was determined from the measurement result. The same analysis was carried out for inorganic sulfate ion scavengers A2, B1 to B4, and C1 to C4 and comparative compounds 1 to 3.

### Measurement of Electrical Conductivity of Supernatant

5.0 g of inorganic sulfate ion scavenger A1 was placed in a 100 mL sealable polytetrafluoroethylene pressure-resistant container, 50 mL of pure water was further added thereto, and the container was sealed and treated at 125° C. for 20 hours. After cooling, this solution was filtered using a membrane filter having a pore size of 0.1 μm, and the electrical conductivity (μS/cm) of the filtrate was measured. The result is given in Table 1.

Inorganic sulfate ion scavengers A2, B1 to B4, and C1 to C4 and comparative compounds 1 to 3 were treated in the same manner, and the electrical conductivity (μS/cm) was measured. These results are given in Table 1.

TABLE 1

| | | Sulfate | Amount of | | | |
|---|---|---|---|---|---|---|
| | | ion | sulfate | Amount of | Content | |
| | | exchange | ion | ionic | of sulfate | Electrical |
| | | capacity | leaching | impurities | radical | conductivity |
| | | (meq/g) | out (ppm) | (ppm) | (ppm) | (μS/cm) |
| Ex. 1 | Inorganic sulfate ion scavenger A1 | 2.2 | <1 | 50 | <100 | 50 |
| Ex. 2 | Inorganic sulfate ion scavenger A2 | 4.5 | <1 | 100 | <100 | 50 |
| Ex. 3 | Inorganic sulfate ion scavenger B1 | 0.8 | <1 | 150 | <100 | 20 |
| Ex. 4 | Inorganic sulfate ion scavenger B2 | 0.9 | <1 | 150 | <100 | 30 |
| Ex. 5 | Inorganic sulfate ion scavenger B3 | 1.0 | <1 | 150 | <100 | 40 |
| Ex. 6 | Inorganic sulfate ion scavenger B4 | 1.0 | <1 | 150 | <100 | 30 |
| Ex. 7 | Inorganic sulfate ion scavenger C1 | 4.0 | <1 | 50 | <100 | 8 |
| Ex. 8 | Inorganic sulfate ion scavenger C2 | 2.0 | <1 | 100 | <100 | 30 |
| Ex. 9 | Inorganic sulfate ion scavenger C3 | 2.5 | <1 | 50 | <100 | 15 |
| Ex. 10 | Inorganic sulfate ion scavenger C4 | 3.6 | <1 | 10 | <100 | 8 |
| Comp. Ex. 1 | Comparative compound 1 | 2.2 | 150 | 300 | 550 | 350 |
| Comp. Ex. 2 | Comparative compound 2 | 3.9 | <1 | 500 | <100 | 75 |
| Comp. Ex. 3 | Comparative compound 3 | <0.1 | <1 | 10 | <100 | 10 |

Test of Scavenging of Sulfate Ion from Magnesium Hydroxide, Amount of Ionic Impurities, Etc.

### Test of Scavenging of Sulfate Ion

0.5 g of inorganic sulfate ion scavenger A1 and 5.0 g of magnesium hydroxide were placed in a 100 mL sealable polytetrafluoroethylene pressure-resistant container, 50 mL of pure water was further added thereto and mixed well, and the container was sealed and treated at 125° C. for 20 hours. After cooling, this solution was filtered using a membrane filter having a pore size of 0.1 μm, the sulfate ion concentration of the filtrate was measured using ion chromatography, and the numerical value obtained by multiplying by 10 was defined as the amount (ppm) of sulfate ion leaching out from the magnesium hydroxide. The result is given in Table 2.

Inorganic sulfate ion scavengers A2, B1 to B4, and C1 to C4, comparative compounds 1 to 3, and magnesium hydroxide alone without using the inorganic sulfate ion scavenger were treated in the same manner, and the amounts of sulfate ion leaching out were measured. These results are given in Table 2.

### Measurement of Amount of Ionic Impurities and Electrical Conductivity

0.5 g of inorganic sulfate ion scavenger A1 and 5.0 g of magnesium hydroxide were placed in a 100 mL sealable polytetrafluoroethylene pressure-resistant container, 50 mL of pure water was further added thereto, and the container was sealed and treated at 125° C. for 20 hours. After cooling, this solution was filtered using a membrane filter having a pore size of 0.1 μm, and the sulfate ion, nitrate ion, and chloride ion concentrations of the filtrate were measured by ion chromatography. Furthermore, sodium ion and magnesium ion concentrations were measured by ICP. The numerical value obtained by multiplying the sum of the measurement values by 10 was defined as the amount of ionic impurities. The result is given in Table 2. The electrical conductivity (μS/cm) of this filtrate was measured, and the result is given in Table 2.

Inorganic sulfate ion scavengers A2, B1 to B4, and C1 to C4, comparative compounds 1 to 3, and magnesium hydroxide alone without using the inorganic sulfate ion scavenger were treated in the same manner, and the amounts of ionic impurities and the electrical conductivities were measured. These results are given in Table 2.

TABLE 2

| | | Amount of | Amount of ionic | |
|---|---|---|---|---|
| | | sulfate ion | impurities | Electrical |
| | | leaching | leaching out | conductivity |
| | | out (ppm) | (ppm) | (μS/cm) |
| Ex. 1 | Inorganic sulfate | 9 | <100 | 50 |
| | ion scavenger A1 | | | |
| Ex. 2 | Inorganic sulfate | <1 | <100 | 30 |
| | ion scavenger A2 | | | |
| Ex. 3 | Inorganic sulfate | 6 | <100 | 20 |
| | ion scavenger B1 | | | |
| Ex. 4 | Inorganic sulfate | 5 | <100 | 30 |
| | ion scavenger B2 | | | |
| Ex. 5 | Inorganic sulfate | 3 | <100 | 60 |
| | ion scavenger B3 | | | |
| Ex. 6 | Inorganic sulfate | 3 | <100 | 50 |
| | ion scavenger B4 | | | |
| Ex. 7 | Inorganic sulfate | <1 | 150 | 100 |
| | ion scavenger C1 | | | |
| Ex. 8 | Inorganic sulfate | 2 | 120 | 90 |
| | ion scavenger C2 | | | |
| Ex. 9 | Inorganic sulfate | 3 | <100 | 20 |
| | ion scavenger C3 | | | |
| Ex. 10 | Inorganic sulfate | 4 | <100 | 10 |
| | ion scavenger C4 | | | |
| Comp. | Comparative | 25 | 250 | 80 |
| Ex. 1 | compound 1 | | | |
| Comp. | Comparative | <1 | 1500 | 290 |
| Ex. 2 | compound 2 | | | |
| Comp. | Comparative | 17 | 200 | 70 |
| Ex. 3 | compound 3 | | | |
| Comp. | None (Mg(OH)₂ | 15 | 180 | 60 |
| Ex. 4 | alone) | | | |

### Example 11

100 parts of a cresol novolac type epoxy resin (epoxy equivalent 235), 50 parts of a phenol novolac resin (molecular weight 700 to 1,000), 2 parts of triphenylphosphine, 1 part of carnauba wax, 1 part of carbon black, 370 parts of fused silica, 10 parts of magnesium hydroxide, and 2 parts of inorganic sulfate ion scavenger A1 were mixed and kneaded by a hot roll at 80° C. to 90° C. for 3 to 5 minutes. Subsequently cooling and grinding were carried out, thus giving powdered epoxy resin composition 1. This composition 1 was sieved using a 100 mesh sieve, thus giving a 100 mesh pass sample.

Resin kneaded material A1 was prepared by curing the 100 mesh pass sample at 170° C. This resin kneaded material A1 was ground into a size of 2 to 3 mm. A test for leaching out of impurity ions such as sulfate ion was carried out using this ground sample.

### Example 12

A ground sample of resin kneaded material A2 was prepared by the same operation as in Example 11 except that inorganic sulfate ion scavenger A2 was used instead of inorganic sulfate ion scavenger A1.

### Example 13

A ground sample of resin kneaded material B1 was prepared by the same operation as in Example 11 except that inorganic sulfate ion scavenger B1 was used instead of inorganic sulfate ion scavenger A1.

### Example 14

A ground sample of resin kneaded material B2 was prepared by the same operation as in Example 11 except that inorganic sulfate ion scavenger B2 was used instead of inorganic sulfate ion scavenger A1.

### Example 15

A ground sample of resin kneaded material B3 was prepared by the same operation as in Example 11 except that inorganic sulfate ion scavenger B3 was used instead of inorganic sulfate ion scavenger A1.

### Example 16

A ground sample of resin kneaded material B4 was prepared by the same operation as in Example 11 except that inorganic sulfate ion scavenger B4 was used instead of inorganic sulfate ion scavenger A1.

### Example 17

A ground sample of resin kneaded material C1 was prepared by the same operation as in Example 11 except that inorganic sulfate ion scavenger C1 was used instead of inorganic sulfate ion scavenger A1.

### Example 18

A ground sample of resin kneaded material C2 was prepared by the same operation as in Example 11 except that inorganic sulfate ion scavenger C2 was used instead of inorganic sulfate ion scavenger A1.

### Example 19

A ground sample of resin kneaded material C3 was prepared by the same operation as in Example 11 except that inorganic sulfate ion scavenger C3 was used instead of inorganic sulfate ion scavenger A1.

### Example 20

A ground sample of resin kneaded material C4 was prepared by the same operation as in Example 11 except that inorganic sulfate ion scavenger C4 was used instead of inorganic sulfate ion scavenger A1.

### Comparative Example 5

A ground sample of comparative resin kneaded material 1 was prepared by the same operation as in Example 11 except that comparative compound 1 was used instead of inorganic sulfate ion scavenger A1.

### Comparative Example 6

A ground sample of comparative resin kneaded material 2 was prepared by the same operation as in Example 11 except that comparative compound 2 was used instead of inorganic sulfate ion scavenger A1.

### Comparative Example 7

A ground sample of comparative resin kneaded material 3 was prepared by the same operation as in Example 11 except that comparative compound 3 was used instead of inorganic sulfate ion scavenger A1.

### Comparative Example 8

A ground sample of comparative resin kneaded material 0 was prepared by the same operation as in Example 11 except that inorganic sulfate ion scavenger A1 was not used. That is, comparative resin kneaded material 0 does not contain an inorganic anion exchanger.

Test of Leaching Out of Sulfate Ion, Etc. from Resin Kneaded Material

5 g of resin kneaded material A1 and 50 mL of pure water were put into a polytetrafluoroethylene pressure-resistant container and sealed, and heated at 125° C. for 100 hours. After cooling, the water was taken out, and the concentrations of sulfate ion and other ionic impurities leaching out into the water were measured by ion chromatography and ICP. The results are given in Table 3.

Resin kneaded materials A2, B1 to B4, and C1 to C4 and comparative resin kneaded materials 1 to 3, and 0 were also subjected to the same test, and these results are given in Table 3.

TABLE 3

| | | Concentration | Concentration |
|---|---|---|---|
| | | of sulfate ion | of impurity ion |
| | | (ppm) | (ppm) |
| Ex. 11 | Resin kneaded material A1 | 25 | <100 |
| Ex. 12 | Resin kneaded material A2 | <1 | <100 |
| Ex. 13 | Resin kneaded material B1 | 20 | <100 |
| Ex. 14 | Resin kneaded material B2 | 16 | <100 |
| Ex. 15 | Resin kneaded material B3 | 10 | <100 |
| Ex. 16 | Resin kneaded material B4 | 10 | <100 |
| Ex. 17 | Resin kneaded material C1 | 10 | 150 |
| Ex. 18 | Resin kneaded material C2 | 7 | <100 |
| Ex. 19 | Resin kneaded material C3 | 10 | <100 |
| Ex. 20 | Resin kneaded material C4 | 13 | <100 |
| Comp. | Comparative resin kneaded | 51 | 250 |
| Ex. 5 | material 1 | | |
| Comp. | Comparative resin kneaded | <1 | 1,500 |
| Ex. 6 | material 2 | | |
| Comp. | Comparative resin kneaded | 55 | 200 |
| Ex. 7 | material 3 | | |
| Comp. | Comparative resin kneaded | 50 | 180 |
| Ex. 8 | material 0 ((MgOH)₂ alone) | | |

As is clear from Table 3, the inorganic sulfate ion scavenger of the present invention has a high capability for scavenging sulfate ion, and when it is added to a seating material resin, it exhibits an effect in suppressing leaching out of sulfate ion and impurity ions. This enables a sealing material composition with high reliability over a wide range to be provided.

### Example 21

### Preparation of Inorganic Scavenging Composition A1

The inorganic sulfate ion scavenger A1 prepared in Example 1 and zirconium α-phosphate, which is a cation exchanger, were mixed well at a ratio by weight of 6:4, thus giving inorganic scavenging composition A1. An ion exchange ratio was measured using inorganic scavenging composition A1.

### Example 22

Inorganic scavenging composition A2 was prepared by the same procedure as in Example 21 except that inorganic sulfate ion scavenger A2 was used instead of inorganic sulfate ion scavenger A1, and the ion exchange ratio was measured.

### Example 23

Inorganic scavenging composition B1 was prepared by the same procedure as in Example 21 except that inorganic sulfate ion scavenger B1 was used instead of inorganic sulfate ion scavenger A1, and the ion exchange ratio was measured.

### Example 24

Inorganic scavenging composition B2 was prepared by the same procedure as in Example 21 except that inorganic sulfate ion scavenger B2 was used instead of inorganic sulfate ion scavenger A1, and the ion exchange ratio was measured.

### Example 25

Inorganic scavenging composition B3 was prepared by the same procedure as in Example 21 except that inorganic sulfate ion scavenger B3 was used instead of inorganic sulfate ion scavenger A1, and the ion exchange ratio was measured.

### Example 26

Inorganic scavenging composition B4 was prepared by the same procedure as in Example 21 except that inorganic sulfate ion scavenger B4 was used instead of inorganic sulfate ion scavenger A1, and the ion exchange ratio was measured.

### Example 27

Inorganic scavenging composition C1 was prepared by the same procedure as in Example 21 except that inorganic sulfate ion scavenger C1 was used instead of inorganic sulfate ion scavenger A1, and the ion exchange ratio was measured.

### Example 28

Inorganic scavenging composition C2 was prepared by the same procedure as in Example 21 except that inorganic sulfate ion scavenger C2 was used instead of inorganic sulfate ion scavenger A1, and the ion exchange ratio was measured.

### Example 29

Inorganic scavenging composition C3 was prepared by the same procedure as in Example 21 except that inorganic sulfate ion scavenger C3 was used instead of inorganic sulfate ion scavenger A1, and the ion exchange ratio was measured.

### Example 30

Inorganic scavenging composition C4 was prepared by the same procedure as in Example 21 except that inorganic sulfate ion scavenger C4 was used instead of inorganic sulfate ion scavenger A1, and the ion exchange ratio was measured.

### Test for Measuring Sulfate Ion Exchange Ratio

5.0 g of inorganic scavenging composition A1 was placed in a 100 mL polypropylene bottle, 50 mL of a 0.01N sodium sulfate aqueous solution was added thereto, and the bottle was sealed and shaken at 40° C. for 24 hours. Subsequently, the solution was filtered using a membrane filter having a pore size of 0.1 μm, and the sulfate ion concentration of the filtrate was measured. The same operation was carried out for the sodium sulfate aqueous solution on its own, and the sulfate ion concentration was measured. The sulfate ion exchange ratio of inorganic scavenging composition A1 was calculated from these measurement values, and is given in Table 4.

Inorganic scavenging compositions A2, B1 to B4, and C1 to C4 were subjected to the same operation, the ion exchange ratios were calculated, and they are given in Table 4. Furthermore, inorganic sulfate ion scavengers A1, A2, B1 to B4, and C1 to C4 were subjected to the same procedure, the ion exchange ratios were calculated, and they are given in Table 4.

TABLE 4

| Sample | Sulfate ion exchange ratio |
|---|---|
| Inorganic scavenging composition A1 | 80% |
| Inorganic scavenging composition A2 | >99% |
| Inorganic scavenging composition B1 | 90% |
| Inorganic scavenging composition B2 | 90% |
| Inorganic scavenging composition B3 | 95% |
| Inorganic scavenging composition B4 | >99% |
| Inorganic scavenging composition C1 | >99% |
| Inorganic scavenging composition C2 | >99% |
| Inorganic scavenging composition C3 | >99% |
| Inorganic scavenging composition C4 | >99% |
| Inorganic sulfate ion scavenger A1 | 5% |
| Inorganic sulfate ion scavenger A2 | >99% |
| Inorganic sulfate ion scavenger B1 | 70% |
| Inorganic sulfate ion scavenger B2 | 80% |
| Inorganic sulfate ion scavenger B3 | 90% |
| Inorganic sulfate ion scavenger B4 | 95% |
| Inorganic sulfate ion scavenger C1 | 40% |
| Inorganic sulfate ion scavenger C2 | 30% |
| Inorganic sulfate ion scavenger C3 | 20% |
| Inorganic sulfate ion scavenger C4 | 7% |

### INDUSTRIAL APPLICABILITY

The inorganic sulfate ion scavenger and the inorganic scavenging composition of the present invention have a superior capability in scavenging sulfate ion to that of existing inorganic anion exchangers. Adding the inorganic sulfate ion scavenger or the inorganic scavenging composition of the present invention to a resin allows an effect in suppressing leaching out of sulfate ion and ionic impurities therefrom to be exhibited. This enables the inorganic sulfate ion scavenger or the inorganic scavenging composition of the present invention to be used in various applications such as sealing, covering, or insulation of an electronic component or an electrical component with high reliability over a wide range. Furthermore, the inorganic sulfate ion scavenger or the inorganic scavenging composition of the present invention may also be used in a stabilizer, an anticorrosive, etc. for a vinyl chloride, etc. resin.

1. An inorganic sulfate ion scavenger for which the amount of ionic impurities leaching out in pure water is no greater than 500 ppm and the amount of sulfate ion leaching out in pure water is no greater than 30 ppm.

2. The inorganic sulfate ion scavenger according to claim 1, wherein the sulfate ion exchange capacity is 0.5 to 10 meq/g.

3. The inorganic sulfate ion scavenger according to claim 1, wherein the amount of sulfate radical contained in the inorganic sulfate ion scavenger is no greater than 3,000 ppm.

4. The inorganic sulfate ion scavenger according to claim 1, wherein the inorganic sulfate ion scavenger is selected from the group consisting of a hydrotalcite-like compound and a calcined material thereof, an aluminum compound, an yttrium compound, and a zirconium oxide and a hydrate thereof.

5. The inorganic sulfate ion scavenger according to claim 1, wherein the inorganic sulfate ion scavenger is selected from the group consisting of a hydrotalcite-like compound and a calcined material thereof, an aluminum compound, and an yttrium compound.

6. An inorganic scavenging composition comprising the inorganic sulfate ion scavenger according to claim 1 and an inorganic cation exchanger.

7. An electronic component-sealing resin composition comprising the inorganic sulfate ion scavenger according to claim 1.

8. An electronic component-sealing material formed by curing the electronic component-sealing resin composition according to claim 7.

9. An electronic component formed by sealing an element by means of the electronic component-sealing resin composition according to claim 7.

10. A varnish comprising the inorganic sulfate ion scavenger according to claim 1.

11. A product comprising the varnish according to claim 10.

12. An adhesive comprising the inorganic sulfate ion scavenger according to claim 1.

13. A product comprising the adhesive according to claim 12.

14. A paste comprising the inorganic sulfate ion scavenger according to claim 1.

15. A product comprising the paste according to claim 14.
